(19) United States
(12) Patent Application Publication
(10) Pub. No.: US 2024/0301979 A1
(43) Pub. Date: Sep. 12, 2024

(54) SECURING ASSEMBLY

(71) Applicant: GRIPPLE LIMITED, Sheffield, South Yorkshire (GB)

(72) Inventor: Thomas Reynolds, Sheffield, South Yorkshire (GB)

(21) Appl. No.: 18/573,630

(22) PCT Filed: Mar. 17, 2022
(86) PCT No.: PCT/IB2022/052427

§ 371 Date: Dec. 22, 2023

(30) Foreign Application Priority Data
Jul. 23, 2021 (GB) 2110626.5
Feb. 23, 2022 (GB) 2202477.2

(51) Int. Cl. F16L 53/32; F16G 11/10; F16L 3/06

(52) U.S. Cl. CPC F16L 53/32; F16G 11/108; F16L 3/06

(57) ABSTRACT

There is provided a securing assembly (16), a connecting device (120), an attaching arrangement (24), and a heating arrangement (10) incorporating securing assemblies (16). An elongate member (18) is arrangeable around a first article (12). A connecting device (120) is provided for connecting opposite end regions (19) of an elongate member (18) to each other. An attaching arrangement (24) is also provided for attaching the elongate member (120) to a second article (14), thereby securing the second article (14) to the first article (12).

This invention relates to securing assemblies. More particularly, but not exclusively, this invention relates to securing assemblies for securing an elongate article to another article. Embodiments of the invention relate to securing assemblies for securing elongate heating articles to conduits. This invention also relates to heating arrangements incorporating securing assemblies.

In some industries, in which liquids are transported by pipes, it is necessary to maintain the liquid above a predetermined temperature to prevent the liquid from cooling and changing viscosity. This is effected by the use of heating members, such as cables or conduits, extending longitudinally of the pipe. The heating members are secured to the pipe by tapes extending around the pipe, the heating members being held between the tapes and the pipe. Clamps are provided to clamp the opposite end regions of each tape to each other.

According to one aspect of this invention, there is provided a securing assembly comprising:
an elongate member arrangeable around a first article;
a connecting device for connecting opposite end regions of the elongate member to each other; and
an attaching arrangement for attaching the elongate member to a second article, thereby securing the second article to the first article.

The connection of the opposite end regions of the elongate member to each other may mount the securing assembly on the first article.

According to another aspect of this invention, there is provided a method of attaching first and second articles to each other, the method comprising:
providing an elongate member, and arranging the elongate member around the first article;
providing a connecting device, and using said connecting device for connecting opposite end regions of the elongate member to each other to mount the securing assembly on the first article; and providing an attaching arrangement, and using said attaching arrangement to attach the elongate member to the second article.

According to another aspect of this invention, there is provided a heating arrangement comprising a first article, a second article, and a securing assembly, the second article extending along the first article, wherein the securing assembly comprises:
an elongate member arranged around the first article;
a connecting device for connecting opposite end regions of the elongate member to each other to mount the securing assembly on the first article; and
an attaching arrangement for attaching the elongate member to the second article, thereby securing the second article to the first article.

Thus, by securing the second article to the elongate member, the second article is secured to the first article.

The first article may be a conduit, such as a pipe. The pipe may carry a material. The heating arrangement may heat the material in the pipe. The second article may be an elongate article, such as an elongate heating article.

The elongate heating article may comprise a heating tube along which a heated fluid may flow. Alternatively, the elongate heating article may be an electric heating cable.

The connecting device may comprise a connecting arrangement to connect the end regions of the elongate member to each other. The connecting arrangement may comprise a clamping mechanism.

A tightening arrangement may be provided for tightening the elongate member against the first article. The tightening arrangement may tighten the elongate member around the first article. The connecting device may comprise the tightening arrangement.

According to another aspect of the invention, there is provided a connecting device comprising: a connecting arrangement for connecting opposite end regions of an elongate member to each other; and a tightening arrangement for tightening the elongate member around an article.

The connecting device may comprise two of the connecting arrangements. Each connecting arrangement may engage a respective end region of the elongate member.

Each connecting arrangement may comprise a clamping mechanism. Each clamping mechanism may be arranged to clamp a respective one of the end regions of the elongate member.

The connecting arrangements may include a body. Each clamping mechanism may be housed within the body.

In one embodiment, the tightening arrangement may comprise a spacing member to space the body from the first article, thereby tightening the elongate member. The spacing member may be manipulable to space the connecting arrangement from the first article. In one embodiment, the spacing member may comprise a threaded member.

The method may comprise manipulating the spacing member to space the body from the first article to tighten the elongate member.

The body may define a hole into which the spacing member may be screwed. The spacing member may engage the first article. Screwing the spacing member through the body may cause the spacing member to engage the first article. The engagement of the threaded member with the first article may move the body away from the first article, thereby tightening the elongate member.

The method may comprise screwing the spacing member through the body to engage the first article and move the body away from the first article, thereby tightening the elongate member.

Alternatively, each connecting arrangement may comprise a respective body. Each connecting arrangement may comprise a respective clamping mechanism. Each body may house a respective one of the clamping mechanisms.

Each connecting arrangement may have an entrance opening for the elongate member. Each connecting arrangement may have an exit opening for the elongate member. The entrance openings of each connecting arrangement may face the other connecting arrangement.

Each body may define the entrance opening. Each end region of the elongate member may extend through a respective one of the entrance openings to the clamping mechanism. Each clamping mechanism may clamp the end region of the elongate member received through the respective entrance opening.

Each body may define the exit opening. The elongate member may extend through the respective exit opening member from the clamping mechanism.

The tightening arrangement may extend between the two connecting arrangements. The tightening arrangement may urge the connecting arrangements away from each other to tighten the elongate member. Thus, the end regions of the elongate member may extend alongside the tightening arrangement to be received through the respective entrance openings.

When the end regions of the elongate member are clamped in the connecting arrangements, the connecting arrangements may be moved towards each to loosen the elongate member.

The tightening arrangement may comprise a spacing member for spacing the connecting arrangements from each other. The spacing member may be a resilient spacing member. The spacing member may comprise a spring, such as a compression spring. The spacing member may be compressible to loosen the elongate member.

Each of the bodies may have a guide member for guiding the elongate member to the entrance opening of the other body. Each guide member may define a bore. Each end region of the elongate member may extend through a respective one of the bores. The bores of each guide member may be aligned with the entrance opening of the other body.

The method may comprise inserting the opposite end regions of the elongate member into the connecting arrangements.

The method may comprise arranging each end region of the elongate member alongside the tightening arrangement and inserting each end region into a respective one of the entrance openings to be clamped by the clamping mechanisms.

The method may comprise feeding a respective one of the end regions of the elongate member through the guide member of each body, and thereafter feeding a respective one of the end regions into the entrance opening of the other body.

Each clamping mechanism may comprise a clamping member for clamping a respective one of the end regions of the elongate member. The clamping members may comprise rollers. Alternatively, the clamping members may comprise balls or wedges.

Each clamping mechanism may further include an urging member to urge the clamping member into clamping engagement with the respective end region of the elongate member.

Each connecting device may include a respective clamping formation, such as a clamping wall, against which the clamping member may clamp the respective end region of the elongate member. Each body may comprise the respective clamping formation.

Each connecting device may further include a reaction formation, such as a reaction wall, against which the clamping member may be clamped. Each body may comprise the respective reaction formation.

The attaching arrangement may comprise an engaging formation for engaging the elongate member. The attaching arrangement may comprise a retaining formation for retaining the second article.

According to another aspect of this invention, there is provided an attaching arrangement comprising:
an engaging formation for engaging an elongate member;
and a retaining formation for retaining an article;

The engaging formation may comprise a holding member to hold the elongate member.

The method may comprise arranging the elongate member within the holding member.

The engaging formation may comprise two of the holding members. The holding members may be arranged on opposite sides of the retaining formation. Each of the holding members may hold the elongate member.

The method may comprise arranging the elongate member within each of the holding members.

The retaining formation may comprise a gripping member for gripping the second article. The gripping member may be deformable to grip the second article.

The method may comprise deforming the gripping member around second article to grip the second article.

The retaining formation may comprise two of the aforesaid gripping members. The gripping members may be deformable towards each other to grip the second article.

The method may comprise deforming each gripping member around second article to grip the second article.

The retaining formation may include a central portion from which the, or each, gripping member may extend.

The attaching arrangement may include an insertion portion for insertion between the elongate member and the first article. The insertion portion may be substantially flat. The insertion portion may extend from the holding members.

The insertion portion may be elongate. Alternatively, the insertion portion may be a segment of a circle or other curved shape. The insertion portion may be semi-circular. The insertion portion may be any other suitable shape.

The method may comprise inserting the insertion portion between the elongate member and the first article, and thereafter arranging the elongate member on the, or each, holding member. The elongate member may be held between the central portion and the, or each, holding member.

The heating arrangement may comprise a plurality of the second articles spaced around the first article. The heating arrangement may comprise a plurality of the securing assemblies spaced along the first article.

The elongate member may comprise a wire, wire rope, cable or the like. The attaching arrangement may comprise a clip.

At least one embodiment of the invention will now be described by way of example only, with reference to the accompanying drawings, in which:

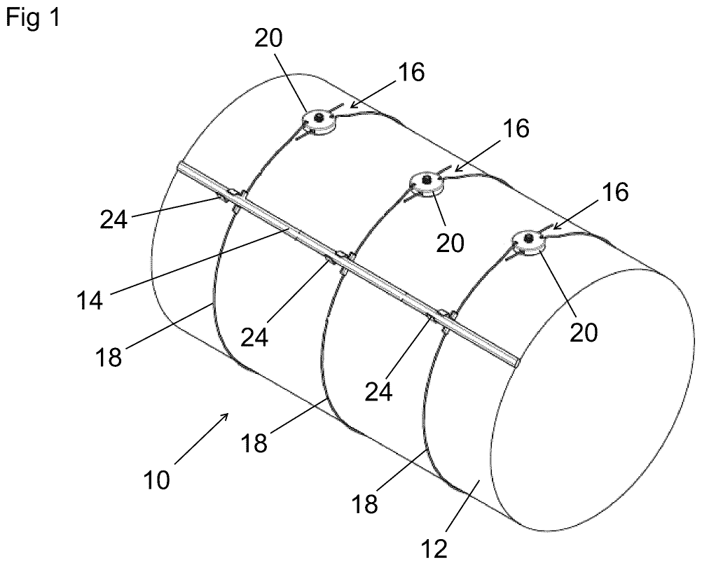

FIG. 1 is a perspective view of a heating arrangement;

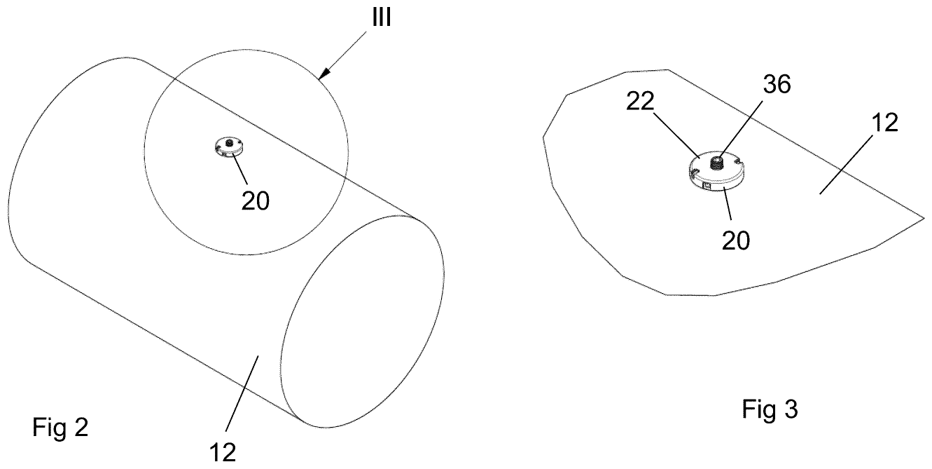

FIG. 2 shows a first step in a method of attaching a first article to a second article;

FIG. 3 is a close up view of the region marked Ill in FIG. 2;

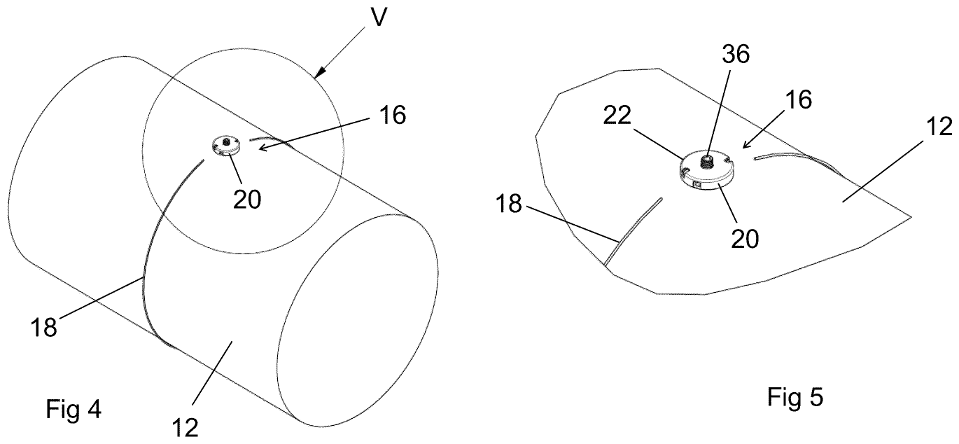

FIG. 4 shows a second step in a method of attaching a first article to a second article;

FIG. 5 is a close up view of the region marked V in FIG. 4;

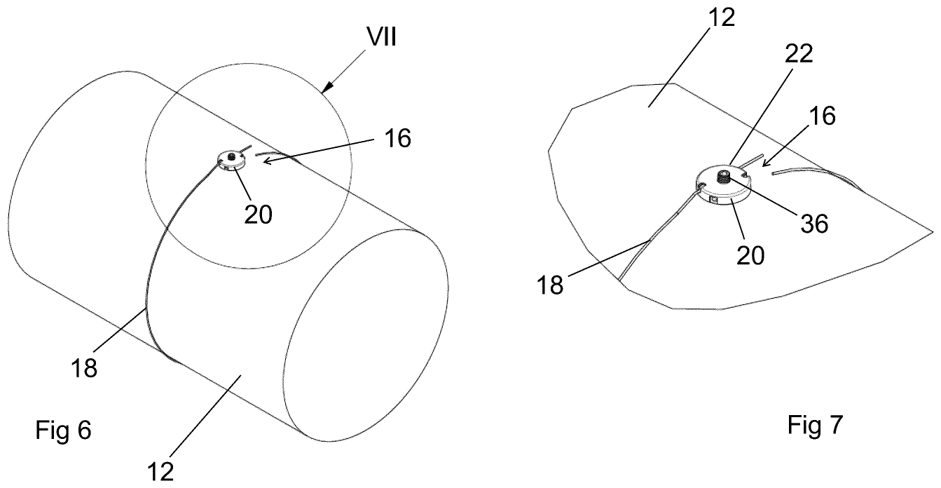

FIG. 6 shows a third step in a method of attaching a first article to a second article;

FIG. 7 is a close up view of the region marked VII in FIG. 6;

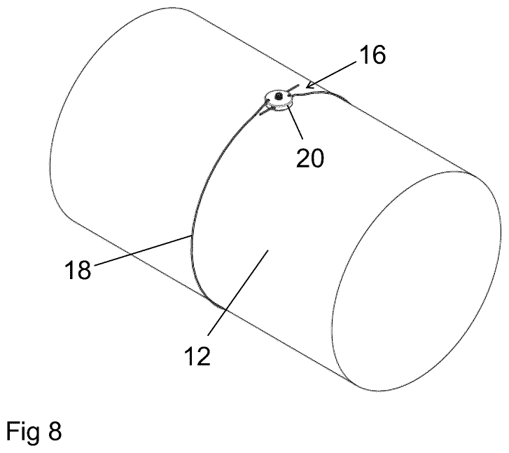

FIG. 8 is a perspective view of a first article with an elongate member and a connecting device securing the elongate member to the first article;

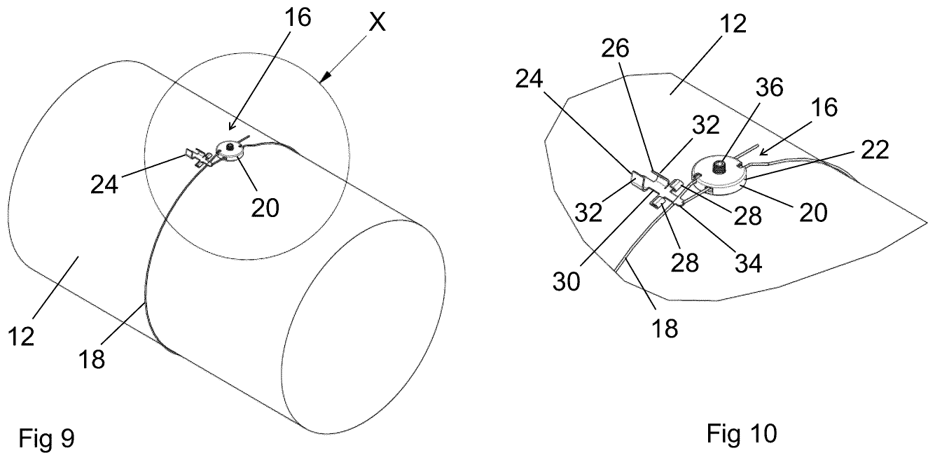

FIG. 9 shows a fourth step in a method of attaching a first article to a second article;

FIG. 10 is a close up view of the region marked X in FIG. 9;

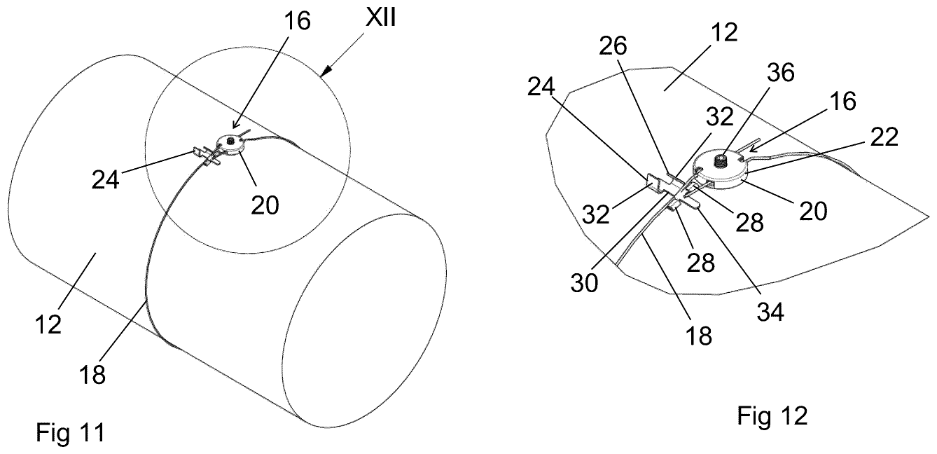

FIG. 11 shows a fourth step in a method of attaching a first article to a second article;

FIG. 12 is a close up view of the region marked XII in FIG. 11;

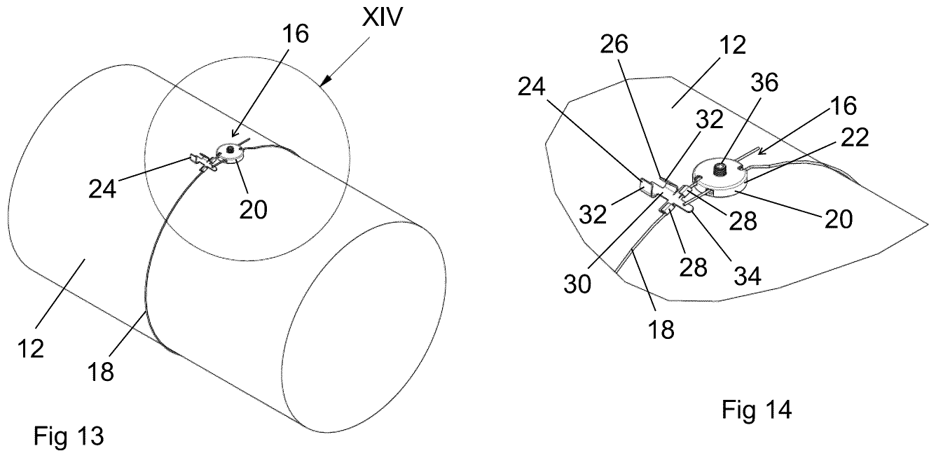

FIG. 13 shows a fifth step in a method of attaching a first article to a second article;

FIG. 14 is a close up view of the region marked XIV in FIG. 13;

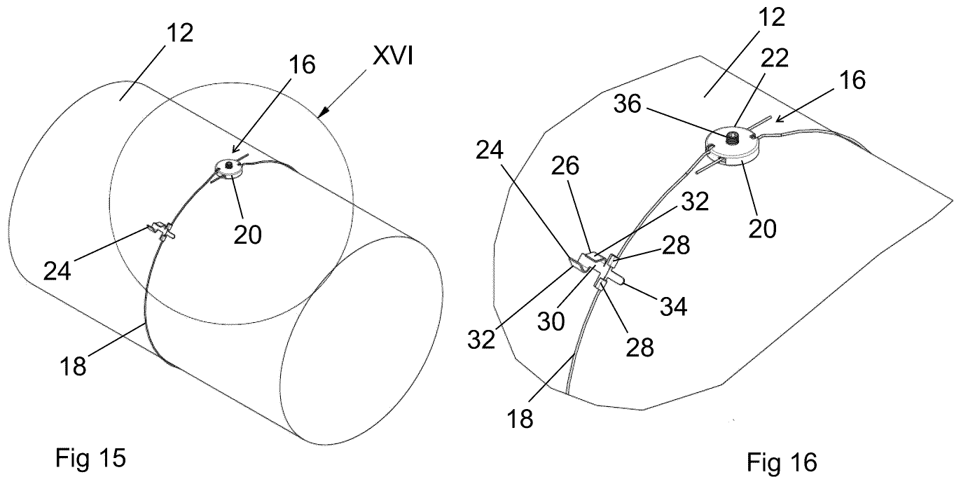

FIG. 15 shows a sixth step in a method of attaching a first article to a second article;

FIG. 16 is a close up view of the region marked XVI in FIG. 15;

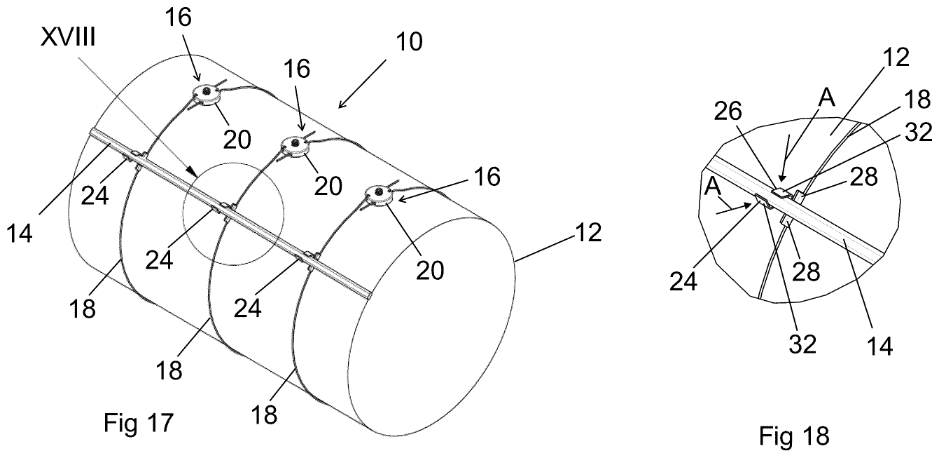

FIG. 17 shows a seventh step in a method of attaching a first article to a second article;

FIG. 18 is a close up view of the region marked XVIII in FIG. 17;

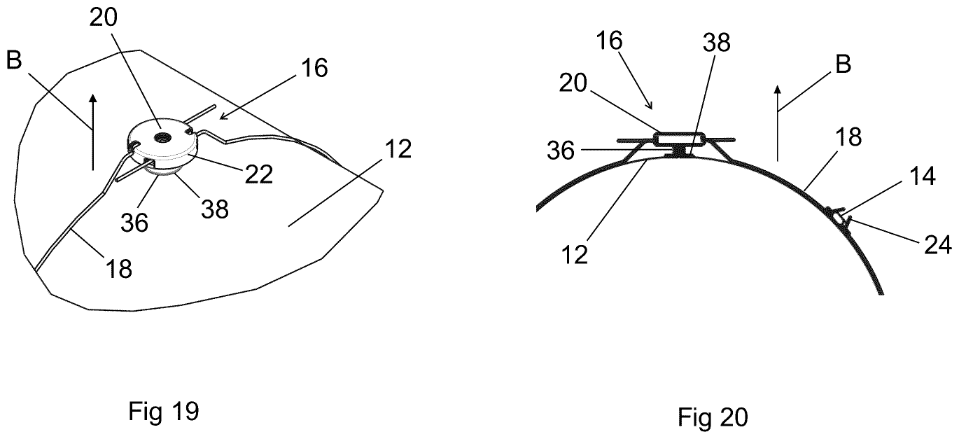

FIG. 19 shows the tightening of the elongate member on the first article;

FIG. 20 is a side view of the view shown in FIG. 19;

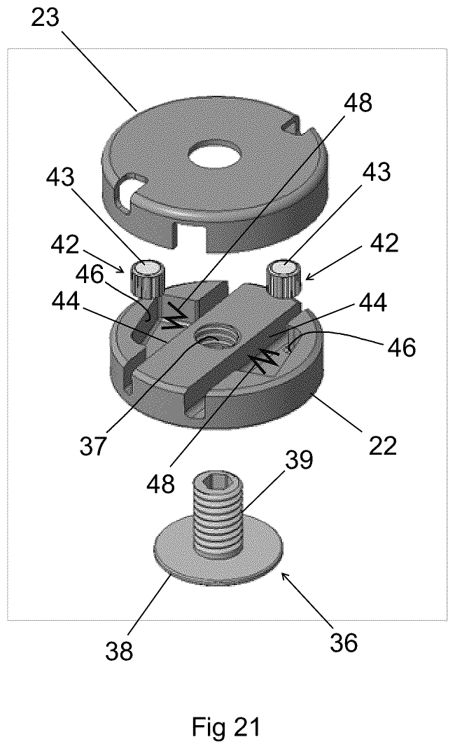

FIG. 21 is an exploded view of a connecting device;

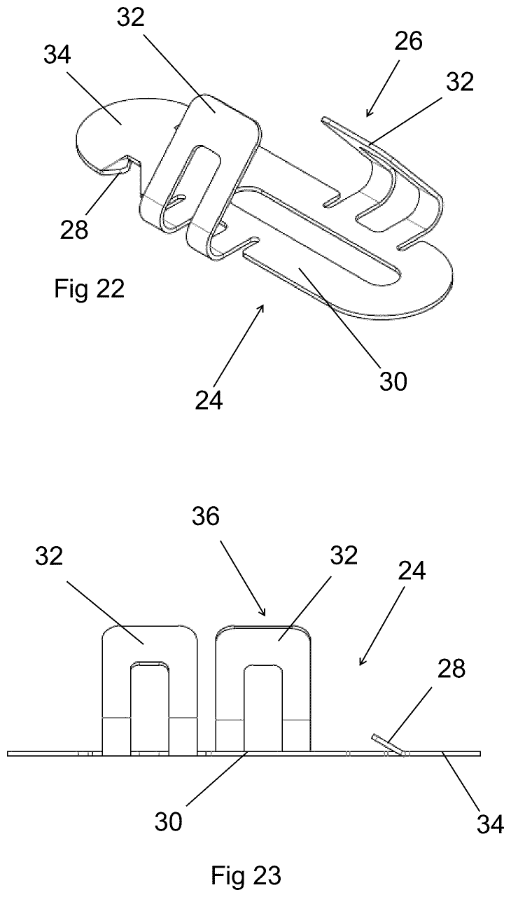

FIG. 22 is a perspective view of an attaching arrangement;

FIG. 23 is a side view of the attaching arrangement;

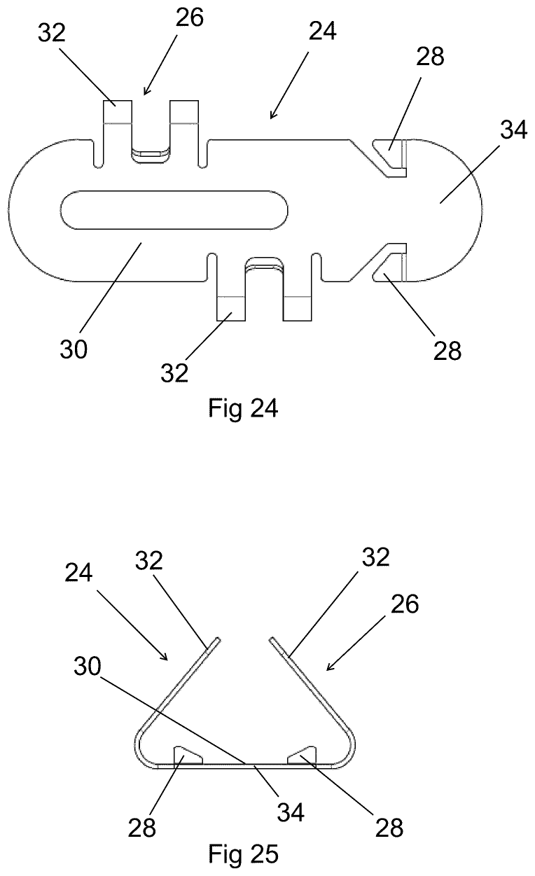

FIG. 24 is a bottom view of the attaching arrangement;

FIG. 25 is an end view of the attaching arrangement;

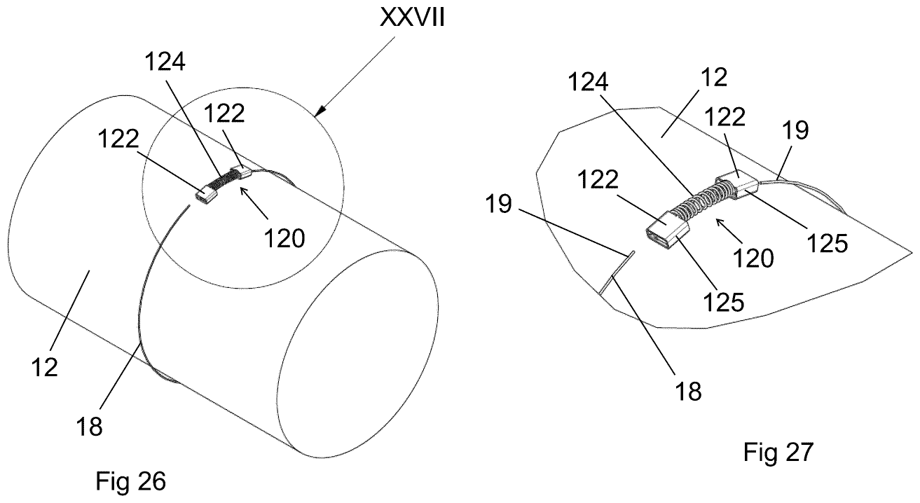

FIG. 26 shows a first step in the use of a further connecting device;

FIG. 27 is a close up view of the region marked XXVII in FIG. 26;

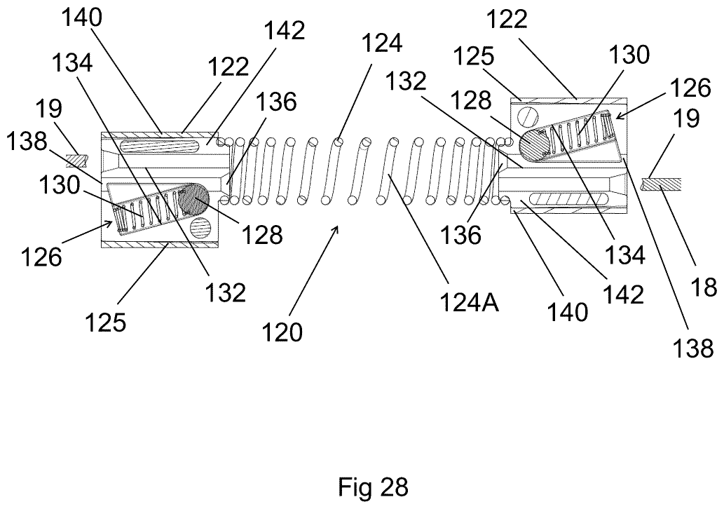

FIG. 28 is a sectional view of the further connecting device in the first step;

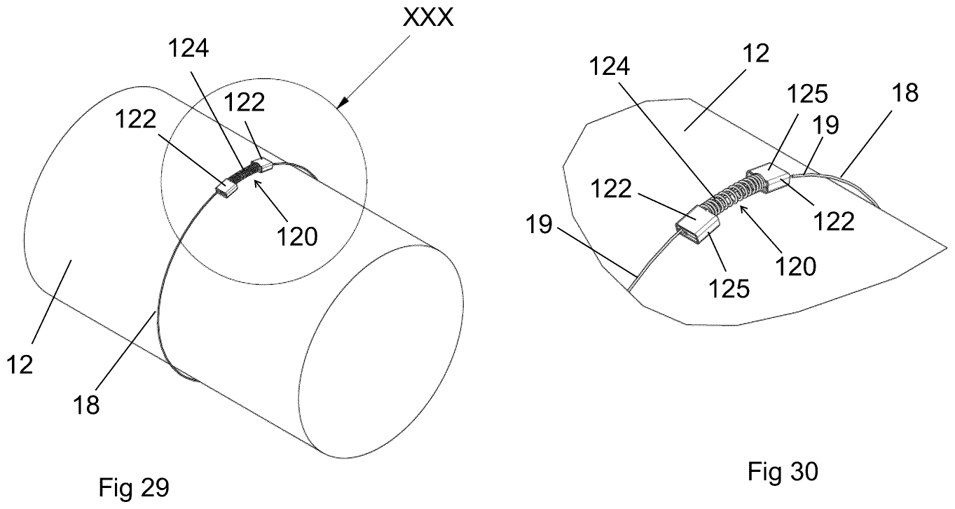

FIG. 29 shows a first step in the use of the further connecting device;

FIG. 30 is a close up view of the region marked XXX in FIG. 29;

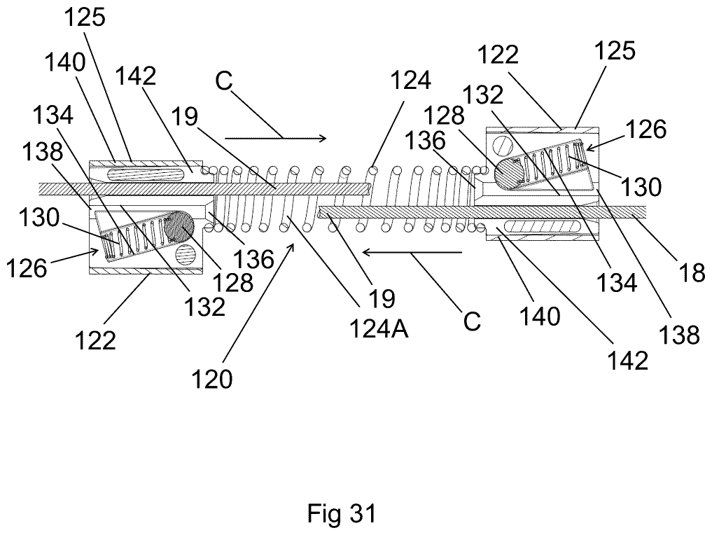

FIG. 31 is a sectional view of the further connecting device in the second step;

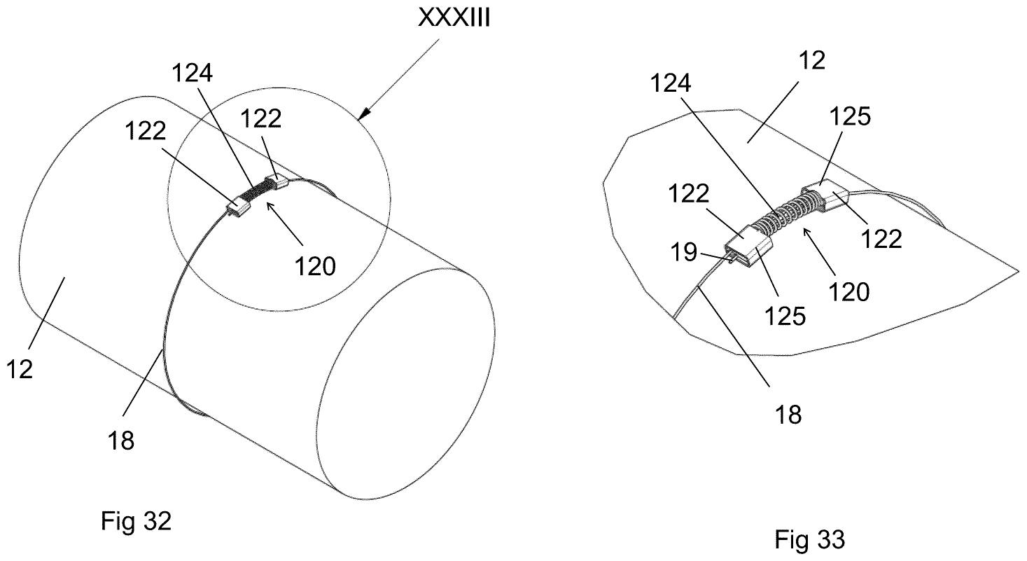

FIG. 32 shows a third step in the use of the further connecting device;

FIG. 33 is a close up view of the region marked XXXIII in FIG. 32;

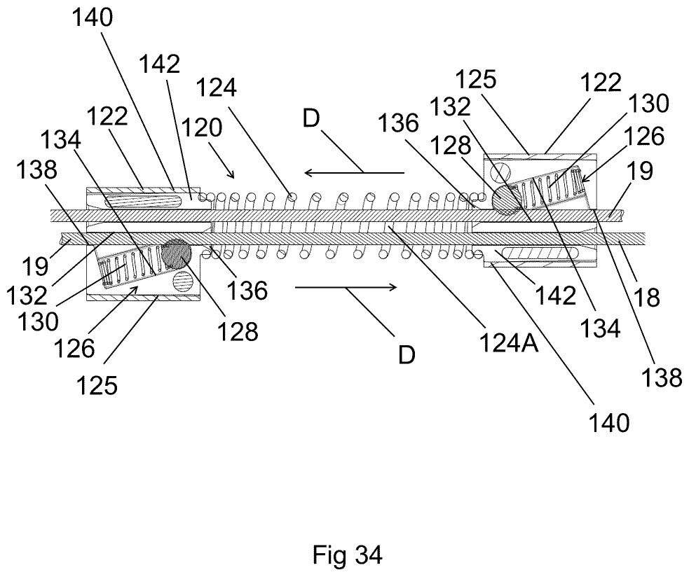

FIG. 34 is a sectional view of the further connecting device in the third step;

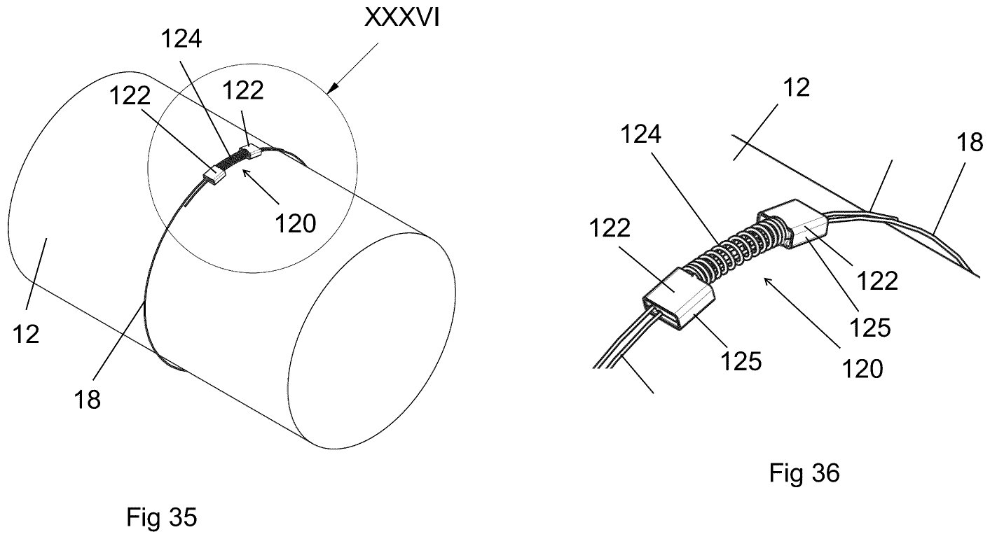

FIG. 35 shows a third step in the use of the further connecting device;

FIG. 36 is a close up view of the region marked XXVI in FIG. 35;

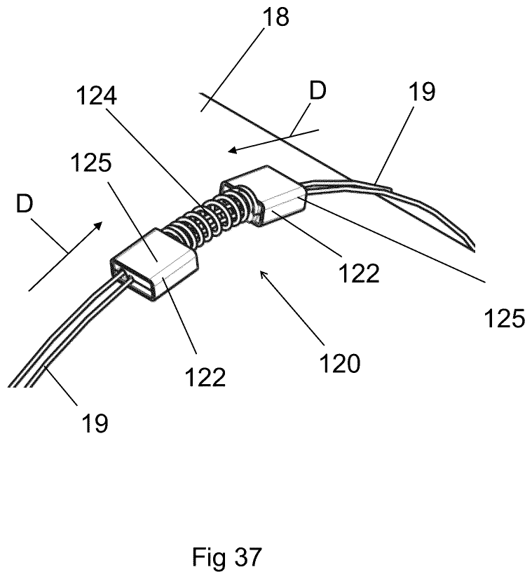

FIG. 37 is shows the further connecting device being used to loosen an elongate member connected thereto;

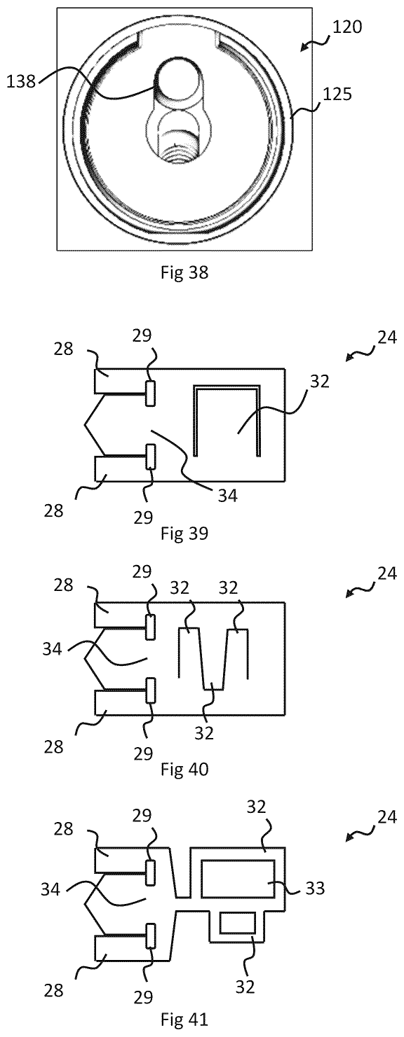

FIG. 38 illustrates an example of a connecting device;

FIG. 39 illustrates an example of a clip;

FIG. 40 illustrates an example of a clip; and

FIG. 41 illustrates an example of a clip.

FIG. 1 shows a heating arrangement 10 comprising a first article in the form of a pipe 12 carrying a material. The heating arrangement 10 further includes a second article in the form of a heating tube 14 through which a heating fluid flows. The heating arrangement 10 heats the material in the pipe 12.

The heating arrangement 10 further includes a plurality of securing assemblies 16 for securing the heating tube 14 to the pipe 12. The securing assemblies 16 are spaced along the pipe 12.

Each securing assembly 16 comprises an elongate member 18 extending around the pipe 12. The elongate member 18 is in the form of a cable, wire, wire rope or the like.

Each securing assembly 16 further includes a connecting device 20 for connecting the opposite end regions 19 of the elongate member 18 to each other. In one embodiment of the invention, shown in FIG. 21, the connecting device 20 comprises a body 22 having a cap 23. The connecting device 20 further includes clamping mechanisms 42 in the body 22 for clamping the opposite end regions 19 of the elongate member 18.

Each clamping mechanism 42 comprises a clamping member 43 for clamping the end regions 19 of the elongate member 18. The body 22 further includes two clamping walls 44 and two reaction walls 46. Each reaction wall 46 converges toward a respective one of the clamping walls 44 to define a narrowing gap therebetween.

The clamping mechanism 42 also has two resilient urging members 48 (shown schematically in FIG. 21). Each urging member 48 is arranged to urge a respective one of the clamping members into the narrowing gap between the respective clamping and reaction walls 44, 46.

Each securing assembly 16 also includes an attaching arrangement in the form of a clip 24 for attaching the heating tube 14 to the elongate member 18. One of the clips 24 is shown in detail in FIGS. 21 to 24. The clip 24 comprises a retaining formation 26 for retaining the heating tube 14, and two holding members 28 for holding the elongate member 18. The holding members 28 are arranged on opposite sides of the retaining formation 26.

The retaining formation 26 comprises a central portion 30 and two deformable gripping members 32 extending from the central portion 30. The gripping members 32 are deformable towards each other to grip the heating tube 14, as indicated by the arrows A in FIG. 18.

The attaching arrangement further includes a substantially flat insertion portion 34 for insertion between the elongate member 18 and the pipe 12. The insertion portion 34 is in the form of a segment of a circle, such as a semi-circle. The insertion portion 34 extends from the central portion 30.

The connecting device 20 further includes a tightening arrangement for tightening the elongate member 18 against the pipe 12. The connecting device 20 may comprise the tightening arrangement.

The tightening arrangement comprise a threaded spacing member 36 screwed into a hole 37 defined in the body 22. The spacing member 36 comprises a substantially flat head portion 38 and a threaded portion 39. The spacing member 36 extends from the body 22 so that the head portion 38 may engage the pipe 12.

Screwing the spacing member 36 through the body 22 moves the head portion 38 into engagement with the pipe 12, and tightens the head portion 38 against the pipe 12. The tightening of the head portion 38 against the pipe 12 has the effect of moving the body 22 away from the pipe 12 as shown by the arrows B in FIGS. 19 and 20, thereby tightening the elongate member 18 against the pipe 12.

In order to mount the securing assembly 16 on the pipe 12, the connecting device 20 is arranged on the pipe 12, and the elongate member 18 arranged around the pipe 12 (see FIGS. 2 to 5). The opposite end regions 19 of the elongate member 18 are then pushed through the connecting device 20 (see FIGS. 6 to 8).

The elongate member 18 is spaced from the pipe 12 at the connecting device 20. This spacing allows the insertion portion 34 to be inserted between the elongate member 18 and the pipe 12 (see FIGS. 9 and 10). Thereafter, the holding members 28 are inserted between the elongate member 18 and the pipe 12 (see FIGS. 11 and 12).

The elongate member 18 is then introduced into the holding members 28, so that the elongate member 18 is held by the holding members 28 (see FIGS. 13 and 14). The clip 24 is then moved to a position at which the heating tube 14 will extend (see FIGS. 15 and 18).

The elongate member 18 may then be tightened against the body 22 by screwing the spacing member 36 through the body 22 so that the head portion 38 engages the pipe 12 (see FIGS. 19 and 20). This moves the body 22 away from the pipe 12 to tighten the elongate member 18 around the pipe 12. Tightening the elongate member 18 against the pipe 12 has the effect of fastening the clip 24 against the pipe 12.

Thus, the spacing member 36 provides the advantage in the embodiment described herein that the clip 24 is fastened in position. It provides the additional advantage that the elongate member 18 can be released thereby allowing a further clip 24 to be added if, for example, a further heating tube 14 is to be installed.

The above steps are then repeated for further securing assemblies 16 to mount a plurality of the securing assemblies 16 on the pipe 12 in a spaced relationship from each other (see FIG. 17).

When a desired number of the securing assemblies 16 are mounted on the pipe 12, the heating tube 14 may be arranged thereon and secured to the pipe 12 by means of the clips 24.

The heating tube 14 is arranged between the gripping members 32 of each clip 24. The gripping members 32 are deformed into gripping engagement with the heating tube 14 to grip the heating tube 14 and, thereby, secure the heating tube 14 to the pipe 12.

There is thus described a securing assembly 16 and a heating arrangement 10 which secure a heating tube 14 to a pipe 12, and which includes a tightening arrangement 36 for fastening a clip 24 to the pipe 12. The tightening arrangement 36 can be released to allow the clip 24 to be removed or a further clip 24 to be added.

Various modifications can be made without departing from the scope of the invention.

A modified version of the connecting device, generally designated 120, is shown in FIGS. 26 to 37. The connecting device 120 comprises two connecting arrangements 122 attached to each other by a tightening arrangement in the form of a resilient spacing member 124.

The resilient spacing member 124 is provided to space the connecting arrangements 122 from each other, and to allow the connecting arrangements to be moved towards each other. In the embodiment shown, the spacing member 124 comprises a compression spring, and defines a central region 124A.

Each of the connecting arrangements 122 comprises a body 125 and a clamping mechanism 126. Each body 125 houses a respective clamping mechanism 126.

Each clamping mechanism 126 comprises a clamping member 128 for clamping a respective one of the end regions 19 of the elongate member 18. In the embodiment shown, the clamping members 128 are in the form of rollers, but it will be appreciated that each clamping member 128 could be any other suitable clamping member, such as a ball or a wedge.

Each clamping mechanism further includes an urging member 130 to urge the clamping member 128 into clamping engagement with the respective end region 19 of the elongate member 18. As shown in FIGS. 28, 31 and 34, the urging members 130 are in the form of compression springs.

Each connecting arrangement 122 further includes a respective clamping formation in the form of a clamping wall 132 of the body 125. The clamping members 128 clamp the end region 19 of each elongate member 18 against the clamping wall 132. Each urging member 130 extends along the respective clamping wall 132.

Each connecting device 120 further includes a reaction formation in the form of a reaction wall 134 of the respective body 125. The reaction wall 134 converges towards the clamping wall 132 to provide a narrowing gap therebetween.

The clamping member 128 clamps the elongate member 18 in the gap between the clamping wall 132 and the reaction wall 134. When the elongate member 18 is so clamped, the clamping member 128 is itself clamped against the reaction wall 134.

Pulling the clamping member 128 and the elongate member 18 into the narrowing gap has the effect of increasing the clamping force on the elongate member 18.

Each of the bodies 125 defines an entrance opening 136 through which the respective end region 19 of the elongate member can be inserted to be clamped by the clamping mechanism 126. The connecting arrangements 122 are arranged so that the entrance opening 136 of each connecting arrangement 122 faces the other connecting arrangement 122.

Each of the bodies 125 further defines an exit opening 138, through which the end region 19 of the elongate member 18 exits the body 125.

Each of the connecting arrangements 122 further includes a guide member 140 defining a through bore 142, through which the respective end region 19 of the elongate member 18 extends. The through bore 142 of each connecting arrangement 122 is aligned with the entrance opening 136 of the other connecting arrangement 122.

In use, the connecting device 120 is arranged on the pipe 12, and the opposite end regions 19 of the elongate member 18 connected thereto, as follows.

Referring to FIGS. 26 to 28, the end regions 19 of the elongate member 18 are presented to the respective guide members 140.

Then, as shown in FIGS. 29 to 31, the end regions 19 are inserted in the direction of the arrows C in FIG. 31, through the bores 142 in the guide members 140 of each of the bodies 125. When so inserted the end regions 19 are received along the central region 124A of the spacing member 124. Thus, each of the end regions 19 is pushed from a respective one of the connecting arrangements 122 towards the entrance opening 136 of the other connecting arrangement 122.

FIGS. 32 to 34 show the further insertion of each of the end regions 19 in the same direction as indicated by the arrows C in FIG. 31. The end regions 19 are pushed through the entrance openings 136 of the respective connecting arrangements 122. The end regions 19 engage the clamping members 128 to push each of the clamping members 128 away from the respective entrance openings 136 along the clamping wall 132, thereby allowing each end region 19 to be pushed through the respective body 125 to exit therefrom via the exit opening 134.

When the end regions 19 have been fully inserted into the connecting arrangements 122, both end regions 19 can then be pulled in the opposite direction, indicated by the arrows D in FIG. 34. This has the effect of pulling the clamping members 128 into the narrowing gaps between the clamping walls 132 and the reactions walls 134. This has the effect of increasing the clamping force on the clamping members 128, thereby ensuring the elongate member 18 is tightly wound around the pipe 12.

FIGS. 35 and 36 show the elongate member 18 wound around the pipe 15. The elongate member is held tightly around the pipe 15 by the connecting device 120. The spacing member 124 pushes the connecting arrangements 122 away from each other to maintain the elongate member 18 tight around the pipe 12.

Referring to FIG. 37, the elongate member 18 can be loosened from its tight engagement around the pipe 12 by moving the connecting arrangements 122 towards each other, as indicated by the arrows D, to compress the spacing member 124.

When the elongate member 18 is loosened, one or more of the clips 24 can be arranged between the elongate member 18 and the pipe 12. The connecting arrangements 122 can then be released to allow them to return to their positions shown in FIGS. 34 and 35. This causes the connecting device 120 to retighten the elongate member 18 around the pipe 12, thereby fastening the, or each, clip 24 against the pipe 12.

The bodies 125 are not limited to the shapes shown in the earlier Figures. FIG. 38 illustrates an example in which one or both of the bodies 125 is cylindrical in cross-section. The outer diameters of the bodies 125 may be approximately the same as the outer diameter of the spacing member 124 therebetween.

FIGS. 39-41 introduce additional examples of the clip 24.

Firstly, FIGS. 39-41 illustrate that the holding members 28 could be different. The holding members 28 of FIGS. 39-41 can hold the elongate member 18 in two different ways, referred to as a ‘bridge’ technique and a ‘return’ technique respectively.

The ‘bridge’ technique is fundamentally similar to how FIGS. 22-25 work. The elongate member 18 passes under a first holding member 28, passes through a wire aperture 29 to an upper surface of the insertion portion 34, then passes through another wire aperture 29 to extend under a second holding member 28. The holding members 28 may be locally deformed at the wire apertures 29.

The ‘return’ technique requires the elongate holding members 28 to be longer than those shown in FIGS. 22-25, and deformable so that they can be deformed over the elongate member 18 in a similar manner to the gripping members 32. The cantilever length ‘L’ of a holding member 28 may be longer than 50% of the circumference of the elongate member 18, or longer than the total circumference of the elongate member 18. In an example, the holding members 28 can be folded by an obtuse angle so that their ends are closer the gripping members 32. A local thin portion of the elongate members 18 at the wire apertures 29 may act as a hinge point for this deformation.

In a further alternative embodiment, the wire apertures 29 can be omitted so that only the ‘return’ technique can be used.

FIGS. 39-41 also illustrate different implementations of the gripping members 32 than FIGS. 22-25.

FIG. 39 demonstrates that a single gripping member 32 could be used, instead of two gripping members.

FIG. 40 demonstrates that three gripping members 32 could be used, instead of two gripping members. Two gripping members 32 are located to one side of the heating tube 14, and the third gripping member 32 is located to the other side of the heating tube 14. The third gripping member 32 is centrally located, with the first and second gripping members 32 to either side of the third gripping member 32.

FIG. 41 is a variant of FIGS. 22-25 in which the two gripping members 32 are not offset from each other. To prevent interference, the first gripping member 32 is narrower than the second gripping member 32 and the second gripping member 32 is wider and comprises an aperture 33 that is wider than the first gripping member 32. Therefore, the first gripping member 32 can be folded over the heating tube 14 and through the aperture 33 of the second gripping member 32, and the second gripping member 32 can be folded over the heating tube 14 without colliding with the first gripping member 32.

In some examples of the disclosure, the entire clip 24 may be supplied in a planar shape prior to deformation of the holding member(s) 28 and prior to deformation of the gripping member(s) 32. The planar shape may comprise a flat shape. The clip 24 may be a sheet of material such as metal, thin enough for the members 28, 32 to be deformed by a user. The flatness of the clip 24 enables the clip 24 to be mass produced, for example by laser cutting, and enables the clip 24 to take up minimal space prior to installation.

1. A securing assembly comprising:
an elongate member arrangeable around a first article, wherein the elongate member comprises one of a wire, a wire rope, or a cable;
a connecting device to connecting opposite end regions of the elongate member to each other, wherein the connecting device comprises one or more clamping mechanisms to connect the end regions of the elongate member to each other; and
an attaching arrangement to attach the elongate member to a second article, thereby securing the second article to the first article.

2. The securing assembly of claim 1, wherein the connection of the opposite end regions of the elongate member to each other mount the securing assembly on the first article.

3. The securing assembly of claim 1, wherein the first article is a pipe.

4. (canceled)

5. The securing assembly of claim 1, wherein the second article is an elongate article.

6. The securing assembly of claim 5, wherein the elongate article is an elongate heating article.

7. The securing assembly of claim 1, comprising a tightening arrangement for tightening the elongate member against the first article.

8. The securing assembly of claim 7, wherein the connecting device comprises the tightening arrangement.

9. (canceled)

10. The securing assembly of claim 1, wherein the connecting device comprises two of the clamping mechanisms, wherein each clamping mechanism is arranged to clamp a respective one of the end regions of the elongate member.

11. The securing assembly of claim 10, wherein the connecting device comprises a pair of bodies, wherein each body houses a respective one of the clamping mechanisms.

12. The securing assembly of claim 11, wherein each body defines an entrance opening for the elongate member, and an exit opening for the elongate member, and wherein the entrance openings of each body face each other.

13. The securing assembly of claim 11, wherein while the end regions of the elongate member are clamped in the bodies, the bodies are movable towards each other to loosen the elongate member.

14. The securing assembly of claim 11, comprising a tightening arrangement to lighten the elongate member against the first article wherein the tightening arrangement extends between the two bodies, and wherein the tightening arrangement is to urge the bodies away from each other to tighten the elongate member.

15. The securing assembly of claim 14, wherein the tightening arrangement comprises a spring to space the bodies from each other, and wherein the spring is compressible to loosen the elongate member.

16. The securing assembly of claim 11, wherein each clamping mechanism comprises:
a clamping member for to clamping a respective one of the end regions of the elongate member; and
an urging member to urge the clamping member into clamping engagement with the respective end region of the elongate member,
and wherein each body comprises:
a clamping formation against which the clamping member clamps the respective end region of the elongate member when in use; and
a reaction formation against which the clamping member is clamped when in use.

17. The securing assembly of claim 1, wherein the attaching arrangement comprises one or more holding members to hold the elongate member, and wherein the attaching arrangement comprises one or more gripping members to retaining the second article.

18. The securing assembly of claim 17, wherein the attaching arrangement comprises two of the holding members, wherein the holding members are arranged on opposite sides of the one or more gripping members, and wherein the one or more gripping members are deformable to grip the second article.

19. (canceled)

20. The securing assembly of claim 17, wherein the one or more holding members are deformable to hold the elongate article.

21. (canceled)

22. A heating arrangement comprising the first article, the second article, and the securing assembly, as claimed in claim 1.

23. A method of attaching first and second articles to each other, the method comprising:
providing an elongate member, wherein the elongate member comprises one of a wire, a wire rope, or a cable, and arranging the elongate member around the first article;
providing a connecting device, and using said connecting device to connect opposite end regions of the elongate member to each other to mount the securing assembly on the first article, wherein the connecting device comprises one or more clamping mechanisms to connect the end regions of the elongate member to each other; and
providing an attaching arrangement, and using said attaching arrangement to attach the elongate member to the second article.

24. A connecting device comprising: a pair of bodies to connect opposite end regions of an elongate member to each other, wherein the elongate member comprises one of a wire, a wire rope or a cable, wherein the connecting device comprises clamping mechanisms each housed in a respective one of the bodies to connect the end regions of the elongate member to each other; and the connecting device further comprising a tightening arrangement extending between the two bodies, to tightening the elongate member around an article.

25. (canceled)
